(19) United States
(12) Patent Application Publication
(10) Pub. No.: US 2024/0283175 A1
(43) Pub. Date: Aug. 22, 2024

(54) CONNECTOR

(71) Applicant: I-PEX Inc., Kyoto-shi (JP)

(72) Inventor: Hisashi HAMACHI, Shizuoka-shi (JP)

(21) Appl. No.: 18/441,801

(22) Filed: Feb. 14, 2024

(30) Foreign Application Priority Data
Feb. 16, 2023 (JP) 2023-022293

(51) Int. Cl. H01R 12/70; H01R 12/72; H01R 12/79

(52) U.S. Cl. CPC H01R 12/7005; H01R 12/72; H01R 12/79

(57) ABSTRACT

A connector includes a housing. The housing includes a terminal placement space, a first insertion space, a first guide, a retraction area, and a second guide. The first guide is placed frontward of the first insertion space on a positive X direction side in an insertion direction in which the first board is inserted and guides insertion of the first board in an inclination direction inclined relative to an X-axis direction. The retraction area is placed continuously with the first guide and retracts a leading edge on a negative X direction side of the first board from the terminal. The second guide is placed continuously with the retraction area, decreases inclination of the first board inserted in the inclination direction, and guides the first board to come into contact with the terminal.

### CROSS-REFERENCE TO RELATED APPLICATIONS

This application claims the benefit of Japanese Patent Application No. 2023-022293, filed on Feb. 16, 2023, the entire disclosure of which is incorporated by reference herein.

### FIELD OF THE INVENTION

This application relates to a connector.

### BACKGROUND OF THE INVENTION

Japanese Registered Utility Model No. 3236706 discloses a card edge connector that includes a body and a terminal housed in the body. The terminal is used to connect a printed circuit board and a flexible flat cable. The terminal includes a first contact part and a second contact part making contact with an electrode plate of a printed circuit board. The first contact part is closer to a leading edge of the terminal than the second contact part. In the card edge connector described in Japanese Registered Utility Model No. 3236706, when a printed circuit board is inserted into the body while a flexible flat cable is inserted into the body, the second contact part of the terminal makes contact with an electrode plate of the printed circuit board, and the first contact part applies load to the flexible flat cable under reaction force.

In the card edge connector described in Japanese Registered Utility Model No. 3236706, when a printed circuit board is inserted into the body, a leading edge of the printed circuit board continues to be in contact with the terminal. Hence, the printed circuit board may be damaged by the contact, and the damage may generate wear debris. Consequently, the wear debris may come between the terminal and the printed circuit board, resulting in increase in electrical resistance of the card edge connector.

The present disclosure has been made under the above-described circumstance, and an objective of the present disclosure is to provide a connector that can prevent generation of wear debris.

### SUMMARY OF THE INVENTION

In order to accomplish the above-described objective, a connector according to the present disclosure includes a housing including: a terminal placement space where a terminal is placed, the terminal including a point of contact with which a first electrode portion of a first board makes electrical contact, a first insertion space into which the first board is inserted, a first guide that is placed frontward of the first insertion space in an insertion direction in which the first board is inserted and guides insertion of the first board in an inclination direction inclined relative to the insertion direction, a retraction area that is placed continuously with the first guide and retracts a leading edge of the first board from the terminal, and a second guide that is placed continuously with the retraction area, decreases inclination of the first board inserted in the inclination direction, and guides the first board to come into contact with the terminal.

The housing may include a second insertion space into which a second board is inserted, and, when the first board inserted into the first insertion space comes into contact with the terminal while the second board is inserted into the second insertion space, a second electrode portion of the second board and the first electrode portion of the first board may be electrically connected to each other via the terminal.

The terminal may include a compression part having a shape capable of pinching the second board, and the second guide may guide the first board so that the first board presses the compression part and the compression part pinches the second board.

The first guide may include a first inclined wall that makes contact with the first board and guides insertion of the first board in the inclination direction, and the first board may include a notch that releases contact with the first inclined wall when a leading edge of the first board is positioned more rearward in the insertion direction than the point of contact.

The housing may include a locking part that locks onto the notch and thereby stops the first board from coming out from the first insertion space.

The first guide may include a second inclined wall that makes contact with the first board and guides insertion of the first board in the inclination direction, and the second inclined wall may include a wall surface that faces another surface on an opposite side from one surface of the first board that faces a wall surface of the first inclined wall while the first board is inserted into the first insertion space.

The retraction area may be a recess provided between the first guide and the second guide.

The connector may include the terminal placed in the terminal placement space of the housing.

In the present disclosure, a retraction area retracts a leading edge of a first board inserted into a first insertion space of a housing from a terminal. Thus, a connector according to the present disclosure prevents the leading edge of the first board inserted into the first insertion space from sliding against the terminal. Thereby, the present disclosure can provide the connector that can prevent generation of wear debris caused by sliding of the first board and the terminal.

### BRIEF DESCRIPTION OF DRAWINGS

A more complete understanding of this application can be obtained when the following detailed description is considered in conjunction with the following drawings, in which:

FIG. 1 is a perspective view (no. 1) of a connector according to the embodiment of the present disclosure;

FIG. 2 is a perspective view (no. 2) of the connector according to the embodiment;

FIG. 3 is a front elevational view of a housing of the connector according to the embodiment;

FIG. 4 is an A-A cross-sectional view of FIG. 3;

FIG. 5 is a B-B cross-sectional view of FIG. 3;

FIG. 6 is a perspective cross-sectional view illustrating in cross-section a part of the connector according to the embodiment, and is a view corresponding to the B-B cross-section of FIG. 3;

FIG. 7 is a view (no. 1) corresponding to the A-A cross-section of FIG. 3 for describing a method of inserting a first board into the housing of the connector according to the embodiment;

FIG. 8 is a view (no. 2) corresponding to the A-A cross-section of FIG. 3 for describing a method of inserting the first board into the housing of the connector according to the embodiment;

FIG. 9 is a view (no. 3) corresponding to the A-A cross-section of FIG. 3 for describing a method of inserting the first board into the housing of the connector according to the embodiment;

FIG. 10A is a view (no. 4) corresponding to the A-A cross-section of FIG. 3 for describing a method of inserting the first board into the housing of the connector according to the embodiment;

FIG. 10B is a view (no. 1) corresponding to the B-B cross-section of FIG. 3 for describing a method of inserting the first board into the housing of the connector according to the embodiment;

FIG. 11A is a view (no. 5) corresponding to the A-A cross-section of FIG. 3 for describing a method of inserting the first board into the housing of the connector according to the embodiment;

FIG. 11B is a view (no. 2) corresponding to the B-B cross-section of FIG. 3 for describing a method of inserting the first board into the housing of the connector according to the embodiment; and

FIG. 12 is a perspective view of a connector according to a modified example.

### DETAILED DESCRIPTION OF THE INVENTION

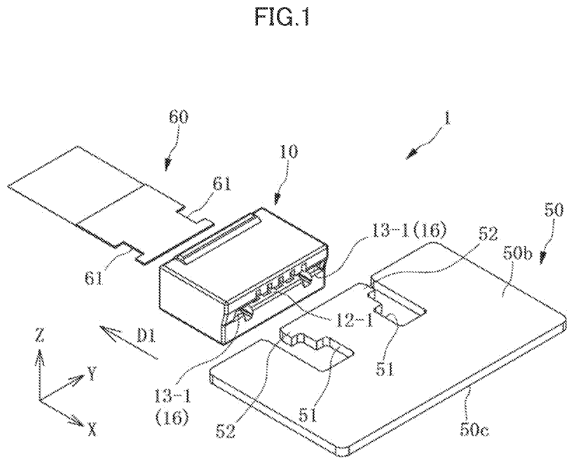

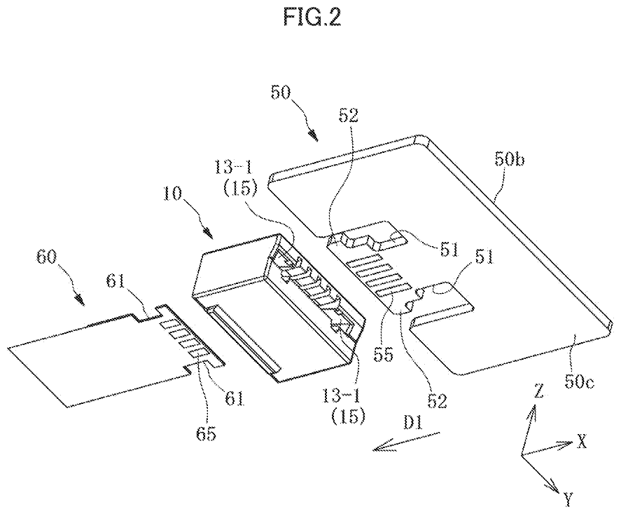

Hereinafter, a connector 1 according to the embodiment of the present disclosure is described with reference to drawings. Note that, for ease of understanding, mutually orthogonal XYZ coordinates are set and referenced as appropriate. A negative X direction of the XYZ coordinates is a direction same as an insertion direction D1 in which a first board 50 is inserted into a housing 10, as illustrated in FIGS. 1 and 2. A Z-axis direction is a direction same as a thickness direction of the first board 50. A Y-axis direction is a direction orthogonal to both of an X-axis direction and the Z-axis direction, and is a direction same as a width direction of the housing 10.

The connector 1 according to the present embodiment is a card edge connector to be attached to the first board 50. The connector 1 is, for example, an electronic circuit component equipped in an automotive part, and is used to connect the first board 50 and a second board 60.

The first board 50 according to the present embodiment is a printed board that includes one surface 50b facing in the positive Z direction, another surface 50c on an opposite side therefrom and facing in the negative Z direction, and an electrically conductive first electrode portion 55 on the another surface 50c. However, the first board 50 is not limited thereto. The first board 50 is not limited to a printed board, but may be a board of another type. The first board 50 is provided with two notches 51 that are cut out from an edge on a negative X direction side.

The second board 60 according to the present embodiment is a flexible printed board. However, the second board 60 is not limited thereto. The second board 60 may be a board other than a flexible printed board. The second board 60 includes an electrically conductive second electrode portion 65 on a back surface facing in the negative Z direction. Further, the second board 60 is provided with parts to be locked 61 that are cut out from both sides in the width direction (the Y-axis direction).

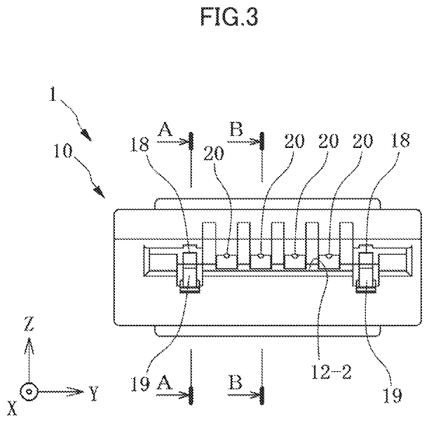

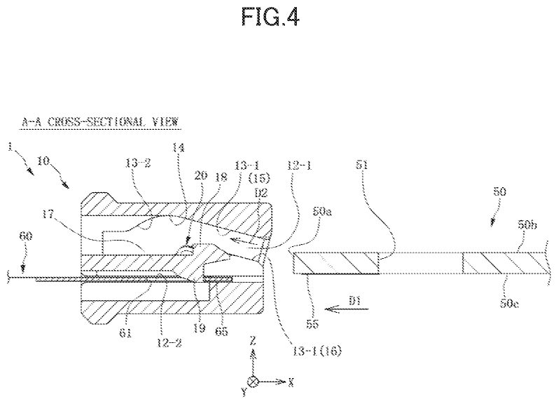

The connector 1 that connects the first board 50 and the second board 60 includes the housing 10 and a plurality of terminals 20, as illustrated in FIGS. 3 and 4.

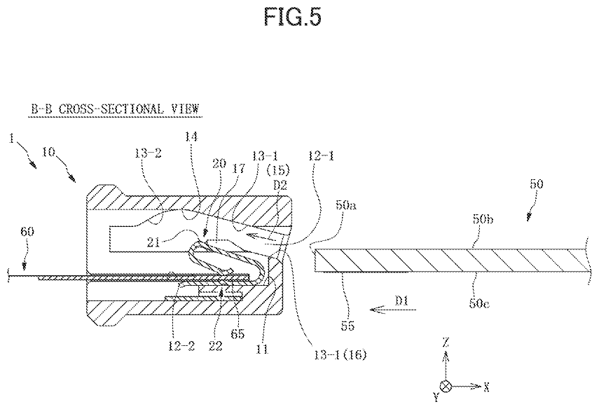

The housing 10 accommodates and protects the terminals 20. The housing 10 is made of, for example, an insulating material. Specifically, the housing 10 is manufactured by, for example, injection molding a resin. However, a material or a method of manufacturing the housing 10 is not limited thereto, but may be a material or a method other than the above. The housing 10 includes a terminal placement space 11, a first insertion space 12-1, a first guide 13-1, a retraction area 14, a second insertion space 12-2, and a second guide 13-2, as illustrated in FIGS. 4 and 5.

The terminal placement space 11 is a space where the terminal 20 is accommodated, as illustrated in FIG. 5. The terminal placement space 11 accommodates the terminal 20 with a point of contact 21 of the terminal 20 protruding in the positive Z direction (upward direction).

The first insertion space 12-1 is a space into which the first board 50 is inserted, as illustrated in FIGS. 4 and 5. The first insertion space 12-1 is provided near an opening at an edge of the housing 10 on a positive X direction side.

The first guide 13-1 is placed frontward of the first insertion space 12-1 (on the positive X direction side) in the insertion direction D1. The first guide 13-1 is for guiding insertion of the first board 50 in an inclination direction D2 inclined relative to the insertion direction D1. The first guide 13-1 includes a first inclined wall 15 and a second inclined wall 16.

When the first board 50 inserted into the first insertion space 12-1 comes into contact with the first inclined wall 15, the first inclined wall 15 guides insertion of the first board 50 in the inclination direction D2. The first inclined wall 15 is a wall portion including a ceiling wall surface that faces the one surface 50b of the first board 50 while the first board 50 is inserted into the first insertion space 12-1.

When the first board 50 inserted into the first insertion space 12-1 comes into contact with the second inclined wall 16, the second inclined wall 16 guides insertion of the first board 50 in the inclination direction D2 together with the first inclined wall 15. The second inclined wall 16 is a wall portion including a bottom wall surface that faces the another surface 50c of the first board 50 while the first board 50 is inserted into the first insertion space 12-1. The second inclined wall 16 according to the present embodiment is near both sides in the width direction (the Y-axis direction) of the opening of the first insertion space 12-1 of the housing 10, as illustrated in FIG. 1. Correspondingly, contact parts 52 for the second inclined wall that make contact with the second inclined wall 16 are on the first board 50 in a way projecting in the width direction (the Y-axis direction). However, the second inclined wall 16 is not limited thereto. The second inclined wall 16 may be on other parts, in addition to near both sides in the width direction (the Y-axis direction) of the opening of the first insertion space 12-1 of the housing 10.

The retraction area 14 is behind the first guide 13-1 (rearward in the negative X direction) in the first insertion space 12-1, and is placed continuously with the first guide 13-1, as illustrated in FIGS. 4 and 5. The retraction area 14 is for retracting a leading edge 50a on the negative X direction side of the first board 50 from the terminal 20. The retraction area 14 according to the present embodiment is provided between the first guide 13-1 and the second guide 13-2, and has a recessed shape when seen in the Y-axis direction.

The second guide 13-2 is behind the retraction area 14 (rearward in the negative X direction) in the first insertion space 12-1, and is placed continuously with the retraction area 14. The second guide 13-2 is for decreasing inclination of the first board 50 inserted in the inclination direction D2 and guiding the first board 50 to come into contact with the terminal 20. The second guide 13-2 according to the present embodiment is provided at a position displaced from the first guide 13-1 in the Y-axis direction so that the second guide 13-2 does not appear in an XZ cross-section same as the first guide 13-1. Thereby, mold removal can be efficiently performed during injection molding of the housing 10. However, the second guide 13-2 is not limited thereto. The second guide 13-2 may be provided at a position where the second guide 13-2 appears in an XZ cross-section same as the first guide 13-1.

The second insertion space 12-2 is a space into which the second board 60 is inserted. The second insertion space 12-2 has an opening at an edge of the housing 10 on a negative X direction side. The second board 60 is inserted into the second insertion space 12-2 from the opening at the edge of the housing 10 on the negative X direction side.

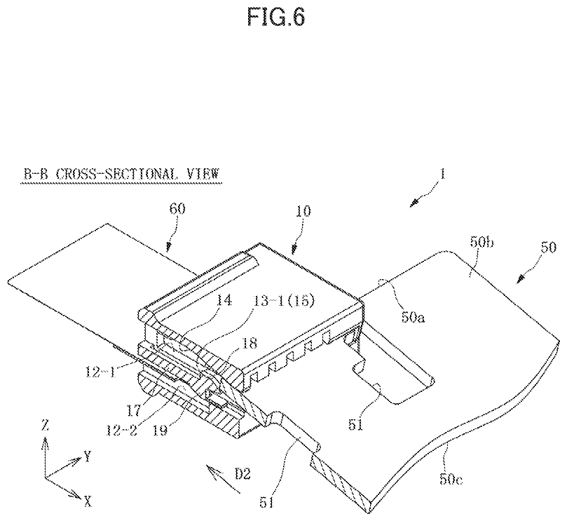

Further, the housing 10 includes an arm for locking parts 17, a locking part 18, and a second locking part 19, as illustrated in FIGS. 4 and 6.

The arm for locking parts 17 is extended, inside the housing 10, in the positive X direction from a part of the housing 10. The arm for locking parts 17 is cantilevered with a leading edge extended in the positive X direction and bendable in the Z-axis direction.

The locking part 18 protrudes in the positive Z direction near the extended leading edge of the arm for locking parts 17. The locking part 18 locks onto the notch 51 of the first board 50. The second guide 13-2 releases, based on the locking, contact between the first board 50 and the first inclined wall 15. The locking part 18 stops the first board 50 from coming out from the first insertion space 12-1.

The second locking part 19 protrudes, near the extended leading edge of the arm for locking parts 17, in the negative Z direction that is a direction opposite from a protruding direction of the locking part 18. The second locking part 19 locks onto the part to be locked 61 of the second board 60. The second locking part 19 stops, based on the locking, the second board 60 from coming out from the second insertion space 12-2. Note that, the part to be locked 61 of the second board 60 that is a target to be locked by the second locking part 19 according to the present embodiment is a notch. However, the part to be locked 61 is not limited thereto. The part to be locked 61 of the second board 60 may have a shape other than a notch. For example, the part to be locked 61 may be an edge of a hole penetrating through the second board 60 in a thickness direction.

The arm for locking parts 17, the locking part 18, and the second locking part 19 according to the present embodiment configured as described above are near both sides in the width direction (the Y-axis direction) one by one inside the housing 10, as illustrated in FIG. 3.

The terminal 20 is a single sheet of elastic and electrically conductive board material made of copper, copper alloy, and the like, as illustrated in FIGS. 4 and 5. Further, the terminal 20 has an arched portion curved to include a portion protruding in the positive Z direction, and is bendable in the Z-axis direction. The terminal 20 includes a point of contact 21 provided at a vertex of the arched portion and making contact with the first electrode portion 55 of the first board 50. Further, the terminal 20 includes, in addition to the point of contact 21, a compression part 22 having a shape capable of pinching the second board 60 inserted into the second insertion space 12-2. The point of contact 21 of the terminal 20 makes contact with the first electrode portion 55 of the first board 50, while the compression part 22 of the terminal 20 pinches the second board 60 in the Z-axis direction and makes contact with the second electrode portion 65 of the second board 60. Thereby, the first electrode portion 55 of the first board 50 and the second electrode portion 65 of the second board 60 are electrically connected to each other via the terminal 20.

A method of inserting the first board 50 into the housing 10 of the connector 1 configured as described above is described by using the drawings.

First, a user who inserts the first board 50 into the housing 10 prepares the housing 10 in which the second board 60 is inserted into the second insertion space 12-2, as illustrated in FIG. 5. The second board 60 inserted into the second insertion space 12-2 is pinched by the compression part 22 of the terminal 20. Thereby, the second electrode portion 65 of the second board 60 is electrically connected to the terminal 20.

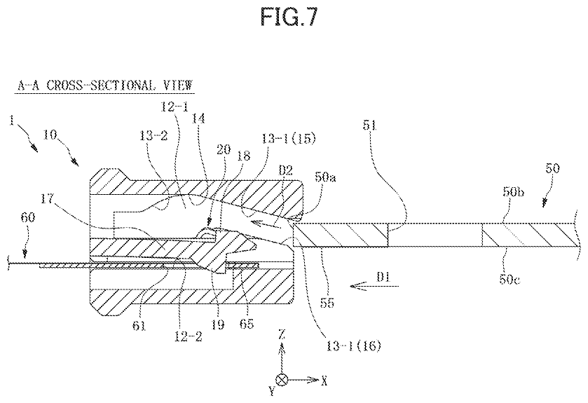

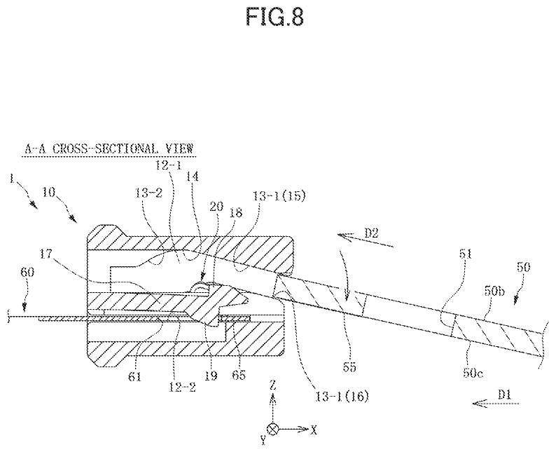

Subsequently, the user inserts the first board 50 into the first insertion space 12-1 of the housing 10 in which the second board 60 is inserted, as illustrated in FIGS. 7 and 8. As the user inserts the first board 50 along the insertion direction D1, the first board 50 is inserted while being guided in the inclination direction D2 by the first guide 13-1. Specifically, the first board 50 is inserted while increasing inclination from the insertion direction D1 to the inclination direction D2 by an action of guidance of the first inclined wall 15 and the second inclined wall 16 of the first guide 13-1. Then, the first board 50 is inserted while maintaining a non-contact state with the terminal 20.

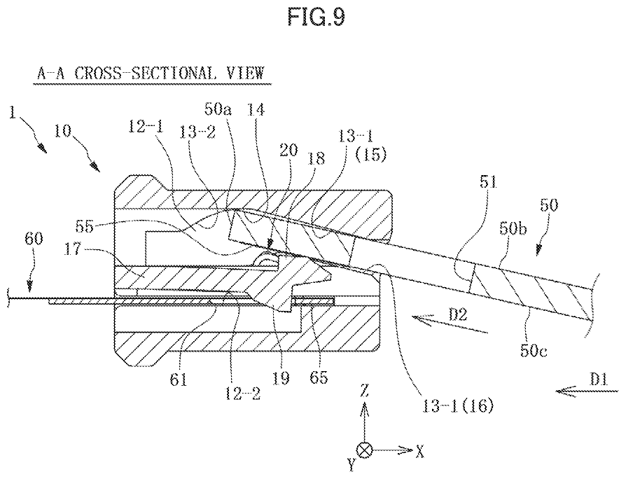

As the first board 50 is inserted while being guided in the inclination direction D2 by the first guide 13-1, the leading edge 50a of the first board 50 reaches the retraction area 14, as illustrated in FIG. 9. When the leading edge 50a of the first board 50 reaches the retraction area 14, the leading edge 50a of the first board 50 is placed apart from the terminal 20 toward the positive Z direction (upward), so that the leading edge 50a of the first board 50 is retracted from the terminal 20. Thereby, the retraction area 14 prevents the first electrode portion 55 of the first board 50 from sliding against the terminal 20 while the first board 50 is inclined relative to the insertion direction D1.

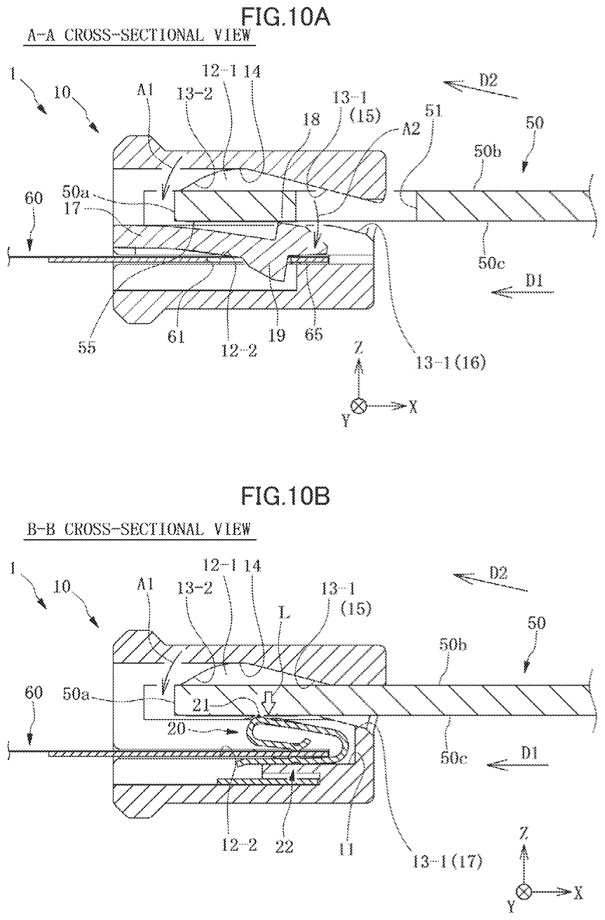

Furthermore, as the first board 50 is inserted into the first insertion space 12-1, the second guide 13-2 decreases inclination of the first board 50 inserted in the inclination direction D2 as indicated by an arrow A1, as illustrated in FIGS. 10A and 10B. At this time, the locking part 18 does not lock onto the notch 51 of the first board 50, and the arm for locking parts 17 bends toward the negative Z direction (downward) as indicated by an arrow A2. Then, the second guide 13-2 releases contact between the first board 50 and the first inclined wall 15, and separates the first board 50 from the first inclined wall 15. The second guide 13-2 guides the first board 50 to come into contact with the terminal 20. Thereby, the second guide 13-2 generates a contact load L of the first board 50 pressing the terminal 20, and brings the first electrode portion 55 of the first board 50 into contact with the terminal 20. Further, the contact load L increases force of the compression part 22 of the terminal 20 pinching the second board 60. As a result, the first electrode portion 55 of the first board 50 and the second electrode portion 65 of the second board 60 are electrically connected to each other via the terminal 20. Further, the contact load L improves locking force of the locking part 18 onto the notch 51 of the first board 50 and locking force of the second locking part 19 onto the part to be locked 61 of the second board 60 upon completion of insertion of the first board 50.

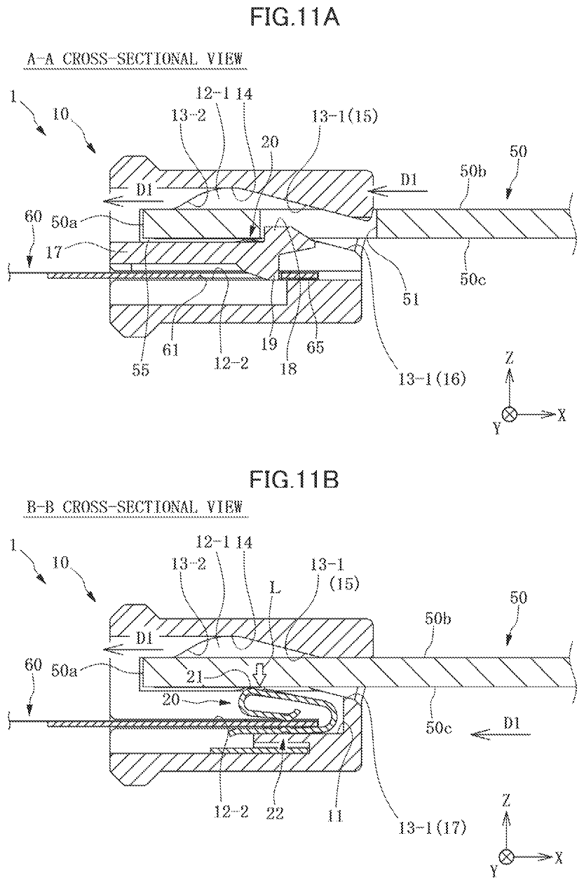

Furthermore, as the first board 50 is inserted into the first insertion space 12-1, the leading edge 50a of the first board 50 eventually slide-moves more rearward (toward the negative X direction) in the insertion direction D1 than the point of contact 21 of the terminal 20, as illustrated in FIGS. 11A and 11B. At this time, the locking part 18 locks onto the notch 51 of the first board 50, and stops the first board 50 from coming out from the first insertion space 12-1. The insertion of the first board 50 into the housing 10 is completed as above.

As described above, in the connector 1 according to the present embodiment, the retraction area 14 retracts the leading edge 50a of the first board 50 inserted into the first insertion space 12-1 from the terminal 20, as illustrated in FIG. 9. Thus, the connector 1 according to the present embodiment prevents the leading edge 50a of the first board 50 inserted into the first insertion space 12-1 from sliding against the terminal 20. Thereby, the present embodiment can provide the connector 1 that can prevent generation of wear debris caused by sliding of the first board 50 and the terminal 20. Consequently, the present embodiment can prevent increase in electrical resistance of the connector 1 due to the wear debris coming between the terminal 20 and the first board 50. Further, the retraction area 14 retracting the leading edge 50a of the first board 50 from the terminal 20 prevents damage on the terminal 20 due to scraped plating or the like. This can prevent increase in electrical resistance of the connector 1.

Further, according to the present embodiment, when the first board 50 inserted into the first insertion space 12-1 of the housing 10 comes into contact with the terminal 20, the second electrode portion 65 of the second board 60 and the first electrode portion 55 of the first board 50 are electrically connected to each other via the terminal 20, as illustrated in FIGS. 10A, 10B, 11A, and 11B. Thereby, the connector 1 according to the present embodiment can improve efficiency in attachment work of the first board 50 into the housing 10 while preventing generation of wear debris caused by sliding of the first board 50 and the terminal 20.

Further, according to the present embodiment, the terminal 20 includes the compression part 22. The second guide 13-2 guides the first board 50 so that the first board 50 presses the compression part 22 and the compression part 22 pinches the second board 60. Thus, the connector 1 can improve electrical connection capability between the first electrode portion 55 of the first board 50 and the second electrode portion 65 of the second board 60 via the terminal 20. Consequently, the connector 1 according to the present embodiment can improve electrical connection capability between the first electrode portion 55 of the first board 50 and the second electrode portion 65 of the second board 60 while preventing generation of wear debris caused by sliding of the first board 50 and the terminal 20.

Further, according to the present embodiment, the first guide 13-1 includes, in addition to the first inclined wall 15, the second inclined wall 16 that faces the first inclined wall 15, as illustrated in FIGS. 7 and 8. Thus, the connector 1 according to the present embodiment can enhance an effect of the first guide 13-1 guiding insertion of the first board 50 in the inclination direction D2. Thereby, the present embodiment can provide the connector 1 that can prevent generation of wear debris caused by sliding of the first board 50 and the terminal 20. Consequently, the present embodiment can prevent increase in electrical resistance of the connector 1 due to the wear debris coming between the terminal 20 and the first board 50.

While the embodiment of the present disclosure has been described above, the present disclosure is not limited by the above embodiment.

For example, according to the present embodiment, the terminal 20 includes the compression part 22 having a shape capable of pinching the second board 60, as illustrated in FIG. 5. The second electrode portion 65 of the second board 60 is electrically connected to the terminal 20 by the compression part 22. However, the terminal 20 is not limited thereto. The terminal 20 may include a portion having a shape other than the shape capable of pinching the second board 60.

Further, according to the present embodiment, the retraction area 14 is a recess provided between the first guide 13-1 and the second guide 13-2, as illustrated in FIGS. 4 and 5. However, the retraction area 14 is not limited thereto. The retraction area 14 may have a shape other than the recess.

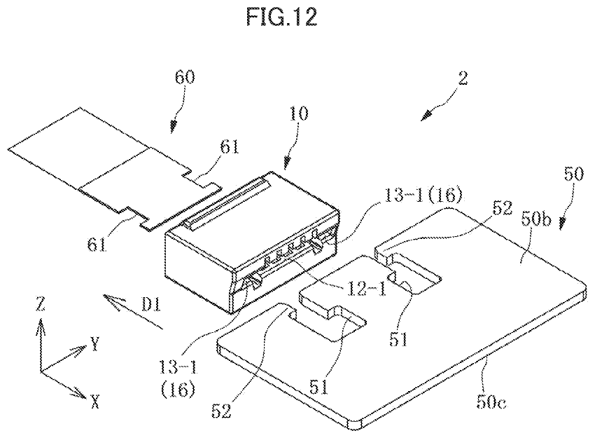

Further, according to the present embodiment, the contact parts 52 for the second inclined wall that make contact with the second inclined wall 16 project mutually in the width direction (the Y-axis direction), as illustrated in FIG. 1. However, the contact parts 52 for the second inclined wall are not limited thereto. The contact parts 52 for the second inclined wall may protrude mutually inward, as in a connector 2 according to a modified example illustrated in FIG. 12.

Further, according to the present embodiment, the locking part 18 locks onto the notch 51 of the first board 50 when the first board 50 slide-moves in the insertion direction D1 in the first insertion space 12-1, as illustrated in FIG. 11A. However, the locking part 18 is not limited thereto. The locking part 18 may lock onto the notch 51 of the first board 50 when the second guide 13-2 decreases inclination of the first board 50 inserted in the inclination direction D2.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.
1, 2: Connector,
10: Housing
11: Terminal placement space
12-1: First insertion space
12-2: Second insertion space
13-1: First guide
13-2: Second guide
14: Retraction area
15: First inclined wall
16: Second inclined wall
17: Arm for locking parts
18: Locking part
19: Second locking part
20: Terminal
21: Point of contact
22: Compression part
50: First board
50a: leading edge
50b: One surface
50c: Another surface
51: Notch
52: Contact part
55: First electrode portion
60: Second board
61: Part to be locked
65: Second electrode portion
D1: Insertion direction
D2: Inclination direction
A1, A2: Arrow
L: Contact load.

### INDUSTRIAL APPLICABILITY

The present disclosure is suitable for use in a connector as an automotive part.

What is claimed is:

1. A connector comprising:
a housing including:
a terminal placement space where a terminal is placed, the terminal including a point of contact with which a first electrode portion of a first board makes electrical contact;
a first insertion space into which the first board is inserted;
a first guide that is placed frontward of the first insertion space in an insertion direction in which the first board is inserted and guides insertion of the first board in an inclination direction inclined relative to the insertion direction;
a retraction area that is placed continuously with the first guide and retracts a leading edge of the first board from the terminal; and
a second guide that is placed continuously with the retraction area, decreases inclination of the first board inserted in the inclination direction, and guides the first board to come into contact with the terminal.

2. The connector according to claim 1, wherein the housing includes a second insertion space into which a second board is inserted, and, when the first board inserted into the first insertion space comes into contact with the terminal while the second board is inserted into the second insertion space, a second electrode portion of the second board and the first electrode portion of the first board are electrically connected to each other via the terminal.

3. The connector according to claim 2, wherein the terminal includes a compression part having a shape capable of pinching the second board, and the second guide guides the first board so that the first board presses the compression part and the compression part pinches the second board.

4. The connector according to claim 1, wherein the first guide includes a first inclined wall that makes contact with the first board and guides insertion of the first board in the inclination direction, and the first board includes a notch that releases contact with the first inclined wall when a leading edge of the first board is positioned more rearward in the insertion direction than the point of contact.

5. The connector according to claim 4, wherein the housing includes a locking part that locks onto the notch and thereby stops the first board from coming out from the first insertion space.

6. The connector according to claim 4, wherein the first guide includes a second inclined wall that makes contact with the first board and guides insertion of the first board in the inclination direction, and the second inclined wall includes a wall surface that faces another surface on an opposite side from one surface of the first board that faces a wall surface of the first inclined wall while the first board is inserted into the first insertion space.

7. The connector according to claim 1, wherein the retraction area is a recess provided between the first guide and the second guide.

8. The connector according to claim 1, further comprising:
the terminal placed in the terminal placement space of the housing.
